(19) United States
(12) Patent Application Publication
(10) Pub. No.: US 2020/0329651 A1
(43) Pub. Date: Oct. 22, 2020

(54) On Top of Ground Weedless No-Till Gardening System

(71) Applicant: Russell L. Perry, JR., McDonough, GA (US)

(72) Inventor: Russell L. Perry, JR., McDonough, GA (US)

(21) Appl. No.: 16/921,026

(22) Filed: Jul. 6, 2020

Related U.S. Application Data
(62) Division of application No. 15/961,092, filed on Apr. 24, 2018.
(60) Provisional application No. 62/608,191, filed on Dec. 20, 2017.

(51) Int. Cl. A01G 24/50; A01G 9/20; A01G 2/00; E02D 5/80

(52) U.S. Cl. CPC A01G 24/50; E02D 5/80; A01G 2/00; A01G 9/20

(57) ABSTRACT

A no-till gardening system is generally comprised of an upper housing unit, a lower housing unit, and at least one securement device. The at least one securement device is further comprised of an attachment tab and an anchoring unit. The upper housing unit is capable of resting upon that of the lower housing unit. A combination of soil and plant seed may be inserted into the space located in between that of the upper and lower housing units. The at least one securement device is used to secure the upper and lower housing units to the ground.

### TECHNICAL FIELD

The present invention relates generally to at-home gardening. More specifically, this invention provides a biodegradable, recyclable garden area which is capable of sustaining weed-less plant life in the absence of any tilling or other soil-disturbing actions.

### BACKGROUND

At-home gardening is a labor intensive process which often presents a number of challenges to the average person who wishes to engage in such a practice. The first problem which is typically encountered by most would-be at-home gardeners is that they often times do not have access to the proper ground or space on which to proceed with a garden. In the event that such land is found, another common concern is the need to employ various types of machinery and/or equipment in order to properly prepare the ground.

Another frustration which often presents itself in this context is at the conclusion of a particular gardening cycle. As a result of common tilling procedures, the soil is often disturbed and distressed to the point where similar gardening practices cannot be repeated on the same plot of ground without first giving the soil a proper recovery period, which can take anywhere from a matter of weeks to a matter of months. The practical result which often flows from such a situation is that the average at-home gardener is forced to miss out on a particular growing season if they do not have access to sufficient land on which to move their current operation.

In the event that these early preparation obstacles are able to be overcome and access can be had to the necessary land and equipment, additional problems with regard to caring for such at-home gardens are almost inevitable. Chief among these concerns is often the ability to control the weeds which are sure to begin growing over time. In addition to weed-related problems, water evaporation is often prevalent. As a result of these two issues operating in tandem with one another, the average at-home gardener is faced with the extremely labor and time intensive task of attempting to maintain the garden unit.

A need therefore presently exists for a no-till garden installation that is able to be set-up and maintained in the absence of any substantial equipment or machinery. Additionally, such a need exists for a garden unit which is capable of being implemented regardless of the existing ground or weather conditions on and around the desired gardening area. Further, a self-contained gardening system is needed which is capable of keeping the soil and seeds from washing away, while also holding in both moisture and heat to better aid the germination process.

### SUMMARY

A no-till gardening system is generally comprised of an upper housing unit, a lower housing unit, and at least one securement device. The at least one securement device is further comprised of an attachment tab and an anchoring unit. The upper housing unit is capable of resting upon that of the lower housing unit. A combination of soil and plant seed may be inserted into the space located in between that of the upper and lower housing units. The at least one securement device is used to secure the upper and lower housing units to the ground.

The no-till gardening system allows for the soil and seed mixture placed between the upper and lower housing units to prosper in a multitude of conditions. The soil layer placed between the upper and lower housing units may be approximately 2 inches high or at the height to support the planting depth recommended by the seed planting instructions, running the length of that of the upper and lower housing units, and stretch to a width of approximately 30 inches. The system may then be watered at regular intervals so as to promote the growth of the plant seed placed therein.

### BRIEF DESCRIPTION OF THE DRAWINGS

The accompanying drawings in the following description illustrate various embodiments of the present disclosure.

FIG. 1 is an aerial perspective of the system showing the perforations located on the outermost face;

FIG. 2 illustrates the system when in the open configuration, thus allowing for the insertion of soil or other growing aids;

FIG. 3 is an isometric view of a securement device for affixing the system to the ground which utilizes an L-shaped anchoring unit;

FIG. 4 is an aerial perspective of an L-shaped anchoring unit affixing the system to the ground;

FIG. 5 is an isometric view of a securement device for affixing the system to the ground which utilizes a U-shaped anchoring unit;

FIG. 6 is an aerial perspective of a U-shaped anchoring unit affixing the system to the ground;

FIG. 7 is an aerial view of a series of systems placed next to one another which have resulted in noticeable plant growth;

FIG. 8 is an aerial perspective of a series of U-shaped anchoring units affixing the system to the ground in the absence of any attachment tabs;

FIG. 9 is an aerial perspective of a weed guard being used to limit the amount of weed growth capable of infiltrating the system;

FIG. 10 is an aerial perspective illustrating a single weed guard being used so as to limit the amount of weed growth capable of infiltrating two systems.

### DETAILED DESCRIPTION

A no-till gardening system is capable of being placed on top of the ground surface so as to not disturb the soil upon which the system rests. The no-till gardening system is comprised of three primary components: a first, or upper, housing unit; a second, or lower, housing unit, and; a means of securing the system to the ground.

In order to implement a no-till gardening system, a plot of land much first be selected. Unlike those gardening applications known to most, the plot of land able to be selected for use with the no-till gardening system of the present invention has very minimal necessary characteristics. So long as a plot or parcel of land is chosen which is of adequate size to support the length and width of the no-till gardening system, such land will be capable of supporting the needs of the system. Those areas of land most commonly associated with the use of an at-home garden are a yard (such as a backyard or side yard, typically populated with grass or the like) or an already existing garden (populated with soil, dirt, or the like). Common factors which may often tend to discourage the placement of an outdoor garden, such as soil fertility, weather conditions, and overall volume of land available, are not critical in choosing the location of the no-till gardening system of the present invention.

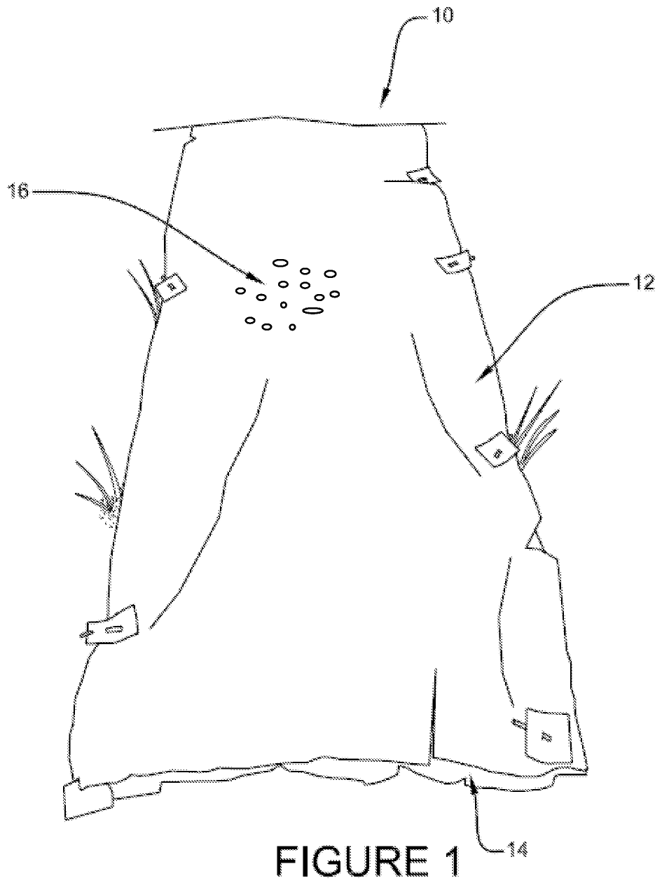

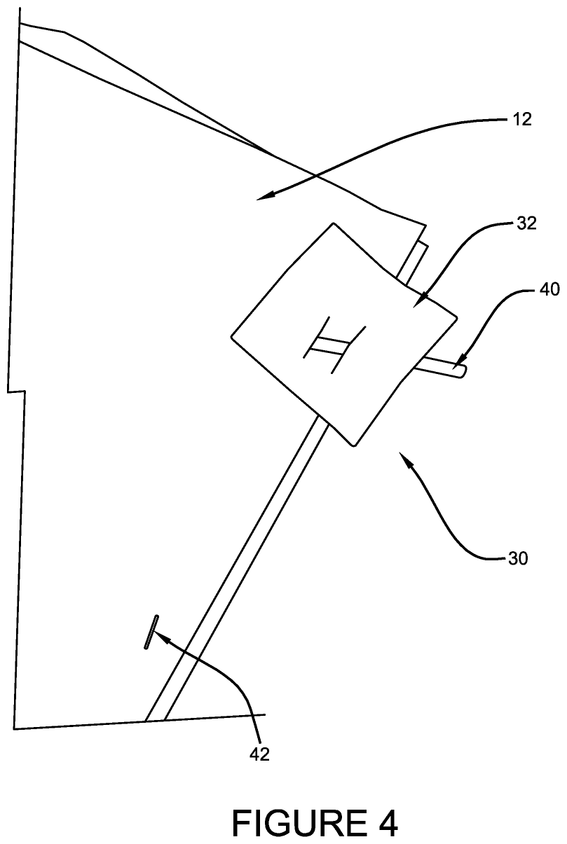

With reference to FIG. 1, a no-till gardening system 10 is shown. The no-till gardening system 10 may be primarily comprised of two housing units: a first, or upper, housing unit 12; and a second, or lower, housing unit 14. As shown in FIG. 1, the upper housing unit 12 may rest upon that of the lower housing unit 14. According to one embodiment of the present invention, the upper housing unit 12 and the lower housing unit 14 may be separate units. However, various other embodiments allow for the upper and lower housing units 12 and 14 to be a single working unit connected by a central spine. According to yet other embodiments, the upper and lower housing units 12 and 14 may be separate units which are thereby connected to one another, such as by way of stitching, gluing, or otherwise, so as to create the functional equivalent of the two independent units being that of a single working unit. By way of one example, the upper housing unit 12 may be affixed to that of the lower housing unit 14 by a series of staples 42 which line the edges of each respective unit, as shown in FIG. 4. Various other examples of the affixed relationship between the upper and lower housing units 12 and 14 may include an adhesive bonding about the outer edges of each respective unit, thus joining the units about their edges in the same manner as accomplished by that of the staples 42 shown in FIG. 4. Yet another example of the affixed relationship may be that of a stitched or sewn nature, in which the upper housing unit 12 is manually stitched to the outer edges of that of the lower housing unit 14 so as to join the two units together.

Returning now to FIG. 1, the no-till gardening system 10 may be placed upon a relatively flat portion of unplowed or untilled ground. According to the embodiment shown in FIG. 1, such a portion of ground primarily consists of grass; however, other surfaces, such as dirt, soil, or similar natural surfaces may also be capable of supporting the no-till gardening system 10.

According to one embodiment, the upper housing unit 12 is placed upon that of the lower housing unit 14. As shown in FIG. 1, the upper housing unit 12 may be the same, or substantially the same, size as that of the lower housing unit 14. Various other embodiments may vary the size of either unit, thus resulting in an upper housing unit 12 which is either larger or smaller than that of the corresponding lower housing unit 14.

The material from which each of the upper and lower housing units 12 and 14 are constructed may be that of any organic or otherwise biodegradable material which does not have any known detrimental effects on either plant life, the environment, or is not otherwise considered hazardous when in contact to, or proximity with, food materials. According to the embodiment shown in FIG. 1, each of the upper housing unit 12 and lower housing unit 14 are constructed from a paper material.

With continued reference to FIG. 1, the upper housing unit 12 may have a series of perforations, punctures, or holes, scattered about the surface thereof. The perforations 16 are intended to pierce through the entirety of the surface of the upper housing unit 12, thus allowing for passage from one side to the other of water or other small particles and materials. The size and number of the perforations 16 may vary according to the specific needs of the no-till gardening system 10. According to certain embodiments, the number of perforations 16 may be quite large, populating a majority of the surface of the upper housing unit 12. Other embodiments, however, may opt for a small number of perforations 16, thus leaving a significant portion of the upper housing unit 12 as a predominantly solid surface. The size of the individual perforations 16 may be determined independent of the total number of perforations 16 present. Further, the size of any individual perforation 16 may vary with regard to those other perforations 16 present on the surface of the upper housing unit 12.

The perforations 16 may be generated by any physical or mechanical means contemplated and available when constructing the no-till gardening system 10. By way of one example, each individual perforation 16 may be created by way of piercing the upper housing unit 12 with a screwdriver or other object possessing a similar pointed edge. According to the specific material chosen for the construction of the upper housing unit 12, the means used for piercing such material in order to create the perforations 16 may need to be adjusted accordingly.

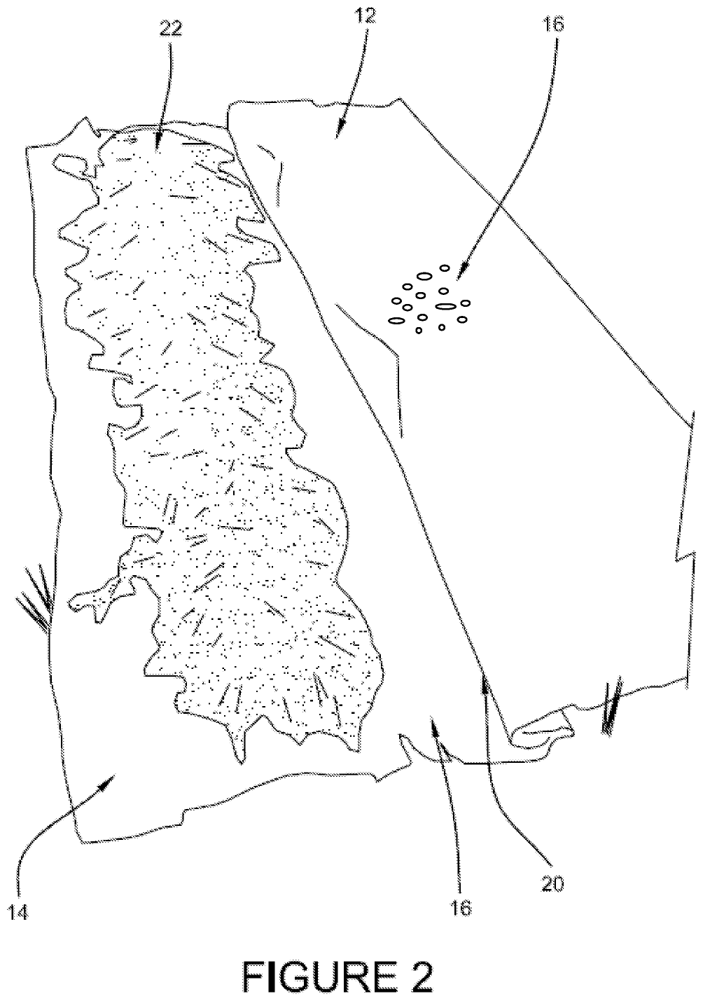

With reference now to FIG. 2, the lower housing unit 14 may be fitted with a series of perforations 16 in the same manner as that of the upper housing unit 12. According to one embodiment, the pattern of perforations on the lower housing unit 14 may directly correspond to that pattern of perforations located on the upper housing unit 12. However, other embodiments allow for the pattern of perforations on each of the upper and lower housing units 12 and 14 to be independent of one another.

With continued reference to FIG. 2, the upper housing unit 12 may be separated from that of the lower housing unit 14 and placed on its reverse side, thus exposing that of the lower housing unit 14. When the upper housing unit 12 and lower housing unit 14 are connected to one another, such as by way of a central spine 20, the now-exposed top surface of the lower housing unit 14 may be described as the interior of the no-till gardening system 10. Soil, seed, fertilizer, and any other desired planting materials may then be placed within the interior of the no-till gardening system 10. The lower housing unit 14 will thus act as a support surface for this plant material.

According to one embodiment, approximately 2 inches or more of bagged, commercial garden soil is first added to the top surface of the lower housing unit 14, covering the approximate length of the lower housing unit 14 at a width of approximately 30 inches. A layer of fertilizer, if so desired, is then applied to the top layer of soil. The combination of soil and fertilizer (if used) then must be smoothed. The means for smoothing the soil may be any which are commonly used in the industry of at-home gardening, such as by way of the back of a rake, with one's shoes, or any other commonly employed means. Depending upon the desires of the gardener, seeds may then be added to the soil per the particular instructions as they pertain to the particular plant or other growth being pursued. Additional soil may be added as needed per the particular seeding instructions. The entirety of the soil, fertilizer, and desired seed mixture is hereinafter referred to as the soil mixture 22.

Once the soil mixture 22 has been placed upon the top surface of the lower housing unit 14, the upper housing unit 12 may be replaced atop the lower housing unit 14. With reference to FIG. 2, the upper housing unit 12 may be again rotated about the central spine 20 such that it covers, or substantially covers, the soil mixture now resting upon the lower housing unit.

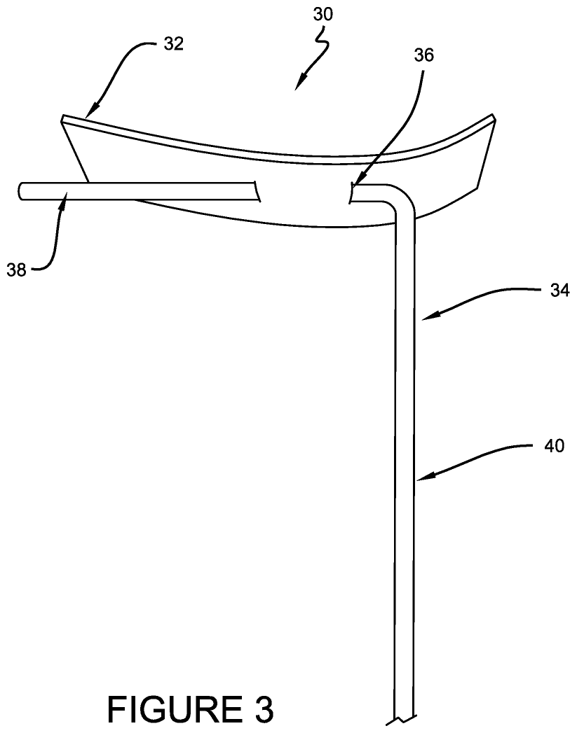

With reference now to FIG. 3, a means of securing the no-till gardening system 10 to the ground is shown. According to one embodiment of the securement means, a securement device 30, or series of securement devices, are used to hold the no-till gardening system 10 securely in place. The securement device 30 is comprised of two primary components: an attachment tab 32 and a corresponding anchoring unit 34. The attachment tab 32 may be of any size and shape as is desired by the gardener. According to the embodiment shown in FIG. 3, the attachment tab 32 is of a generally rectangular shape. The material from which the attachment tab may be manufactured is of the same general nature as each of that of the upper and lower housing units 12 and 14: organic or otherwise biodegradable material which does not have any known detrimental effects on either plant life, the environment, or is not otherwise considered hazardous when in contact to, or proximity with, food materials.

According to the embodiment shown in FIG. 3, the attachment tab 32 is constructed from a similar paper-based material as that of each of the upper and lower housing units 12 and 14, but may be of a more rigid and less flexible composition, such as that of cardboard or the like. The anchoring unit 34 is thus affixed to the attachment tab 32 by way of a fastener 36. According to one embodiment, the fastener 36 is constructed by making two cuts, or slits, into the attachment tab 32 which thus allow for the anchoring unit 34 to be inserted therein.

The anchoring unit 34 may be constructed of similar material as that of each of the upper housing unit 12, lower housing unit 14, and attachment tab 32. By way of one example, the anchoring unit 34 is constructed from a paper stick (sometimes referred to as a “lollipop stick” or “pop stick”). According to the embodiment of the present invention shown in FIG. 3, the anchoring unit 34 may generally be of an “L-shape” design, having an approximate 90 degree bend. The anchoring unit 34 is thus separated into two distinct sections: an upper portion 38 and a lower portion 40. The upper portion 38 is generally defined as that portion of the anchoring unit 34 which is shorter in length. While the exact dimensions of the anchoring unit 34 may be determined with regard to the overall size of the no-till gardening system 10, the upper portion 38 must be of a sufficient length so as to remain secured within that of the fastener 36 and the lower portion 40 must be of a sufficient length so as to remain secured into the ground upon which the no-till gardening system 10 rests. While this length may differ according to various embodiments of the present invention, it is generally estimated that the lower portion 40 be approximately 6 inches in length.

The upper portion 38 may be inserted into the fastener 36 of the attachment tab 32 so as to secure the anchoring unit 34 to the attachment tab 32. The lower portion 40 thus extends away from the upper portion 38 following a bend of approximately 90 degrees. According to one embodiment, the distal end of the upper portion 40 may be sharpened or otherwise altered so as to provide the upper portion 40 with a more secured means of holding the no-till gardening system 10 in place.

With reference now to FIG. 4, the securement device 30 is shown in the affixed position with regard to each of the upper and lower housing units 12 and 14. Using a small tool with a pointed edge, such as a screwdriver or other similar device, a series of holes are punctured through each of the upper and lower housing units 12 and 14 of a diameter approximately equal to that of the upper portion 38 of the anchoring unit 34. The lower portion 40 of the anchoring unit 34 is then inserted through these holes and secured into the ground below. The lower portion 40 is inserted to the maximum depth allowable by the length of the lower portion 40, or to that depth upon which the attachment tab 32 comes into contact with the upper housing unit 12.

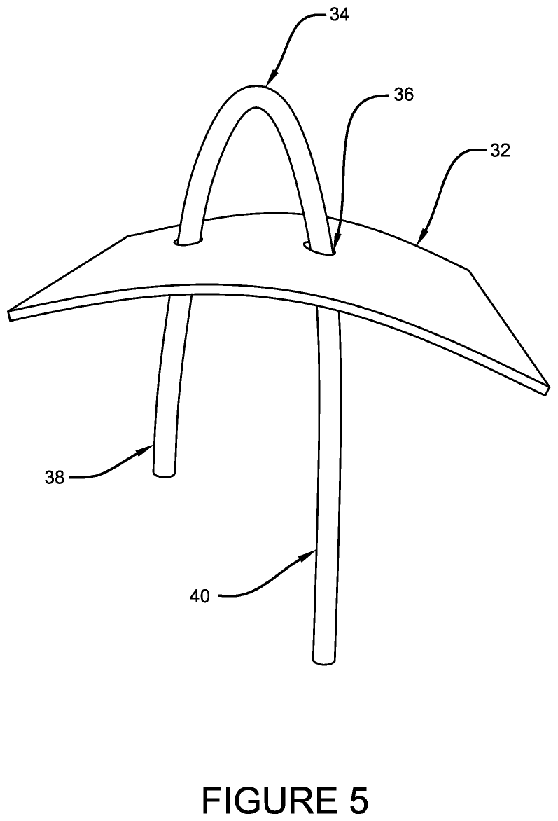

With reference now to FIG. 5, according to another embodiment of the present invention, the anchoring unit 34 may generally be of a “U-shape” design, whereby each of the upper and lower portions 38 and 40 run substantially parallel to one another as the result of having an approximate 180 degree bend in the anchoring unit 34. When utilizing such a U-shaped design for the anchoring unit 34, the fastener 36 may generally be comprised of two cuts, or slits, in the attachment tab 32 which are placed in close proximity to one another. The anchoring unit 34 may then be inserted into the fastener 36 such that each of the respective ends of the anchoring unit (the upper and lower portions 38 and 40) are capable of extending through the attachment tab 32, away from the U-shaped bend, and running substantially parallel to one another.

According to this U-shaped embodiment, the length of the upper and lower portions 38 and 40 may be of similar proportions to that of the L-shaped embodiment wherein the upper portion 38 is shorter in length that that of the lower portion 40. However, the relative lengths of the upper and lower portions 38 and 40 may be of varying lengths according to the U-shaped embodiment, such as where each of the upper and lower portions 38 and 40 are approximately the same length as one another. While the exact dimensions of the anchoring unit 34 may be determined with regard to the overall size of the no-till gardening system 10, each of the upper and lower portions 38 and 40 must be of a sufficient length so as to remain secured within that of the fastener 36 and further capable of keeping the attachment tab 32 secured to the ground upon which the no-till gardening system 10 rests.

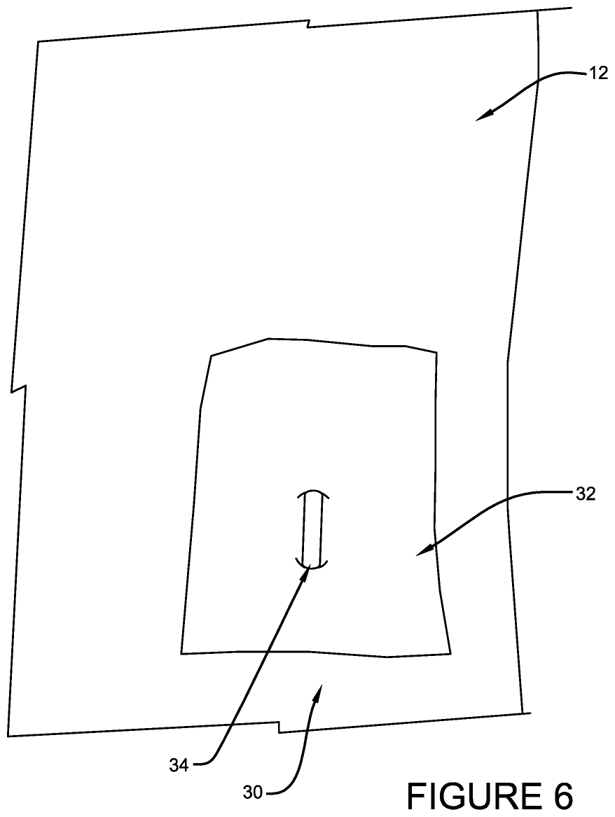

With reference now to FIG. 6, the securement device 30 is shown in the affixed position with regard to each of the upper and lower housing units 12 and 14. Using a small tool with a pointed edge, such as a screwdriver or other similar device, a series of holes are punctured through each of the upper and lower housing units 12 and 14 of a diameter approximately equal to that of the upper and lower portions 38 and 40 of the anchoring unit 34. Each of the upper and lower portions 38 and 40 are then inserted through these holes and secured into the ground below. The upper and lower portions 38 and 40 are inserted to the maximum depth allowable by their respective lengths, or to that depth upon which the attachment tab 32 comes into contact with the upper housing unit 12.

Various configurations of the securement device 30 are contemplated by the present invention, including the overall number of devices present, as well as the particular location of each such device. The intended placement of such securement devices 30 is along the outer perimeter of the no-till gardening system, however other variations may be achieved where applicable. By way of one example, a single securement device 30 is placed in approximately the center of each face of the no-till gardening system 10, thus totaling 4 securement devices in all. By way of another example, a single securement device 30 is placed at each point of intersection between two faces, or each corner, thus also totaling 4 securement devices in all. By way of yet another example, a securement device 30 is first positioned at each corner of the no-till gardening system 10. Subsequent securement devices are then placed at intervals along the perimeter of each face of the system. The intervals may be of any spacing. According to one particular example, a securement device 30 is placed at an interval located 18 inches as measured from the previously placed securement device 30. The total number of securement devices 30 thus present will be dependent upon the overall length and width of the no-till gardening system 10.

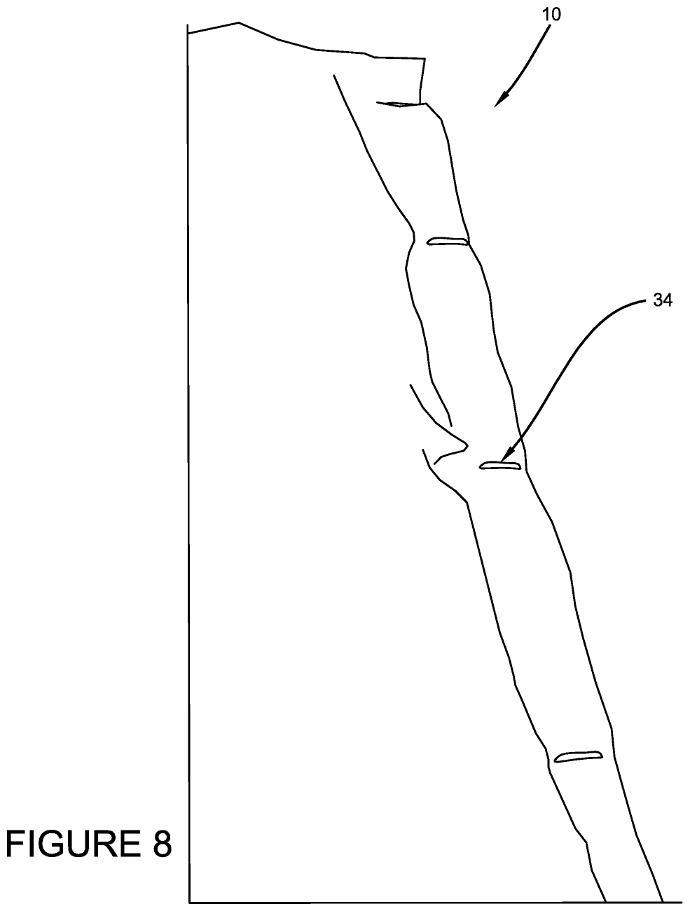

With reference now to FIG. 8, an alternative embodiment of securing the no-till gardening system 10 to the ground is shown. According to this embodiment, an alternative securement device 30 is used to secure the no-till gardening system 10 directly to the ground whereby the anchoring unit 34 is able to operate in the absence of a corresponding attachment tab 32. In the absence of the attachment tab 32, the edges of either, or both, of the upper or lower housing units 12 and/or 14 may be reinforced so as to provide a more substantial outer surface for supporting the anchoring unit 34. According to one embodiment, each of the edges of the upper and/or lower housing units 12 and 14 may be rolled about themselves, or “doubled over,” so as to create a more substantial outer rim about the periphery of the no-till gardening system 10, as shown in FIG. 8. Another example of increasing the stability of the outer edges of the respective housing units so as to allow the anchoring unit 34 to operate in the absence of the attachment tab 32 may be by way of adding additional layers to the outer edges of either of the housing units 12 and/or 14.

Upon such reinforcement of the edges of the upper and lower housing units 12 and/or 14, the anchoring unit 34 may be used to secure the no-till gardening system 10 directly to the ground in the absence of the use of any attachment tabs 32. According to this embodiment, either of the previously discussed configurations of the anchoring unit 34 (L-shaped or U-shaped) may be used for securement purposes. The manner in which either of the respective configurations are secured to the outer edges of the upper and lower housing units 12 and 14 will operate in the same general manner as already outlined herein. By way of one example, when using an L-shaped anchoring unit 34, after puncturing a hole through each of the upper and lower housing units 12 and 14, the lower portion of the anchoring unit 40 may be inserted through such an opening and directly into the ground beneath, with the upper portion of the anchoring unit 38 creating a secured attachment to the upper housing unit 12. Alternatively, if utilizing a U-shaped anchoring unit 34, each of the upper and lower portions of the anchoring unit 38 and 40 may be inserted through the series of openings created in both the upper and lower housing units 12 and 14 such that the anchoring unit 34 may secure the no-till gardening unit 10 directly to the ground below.

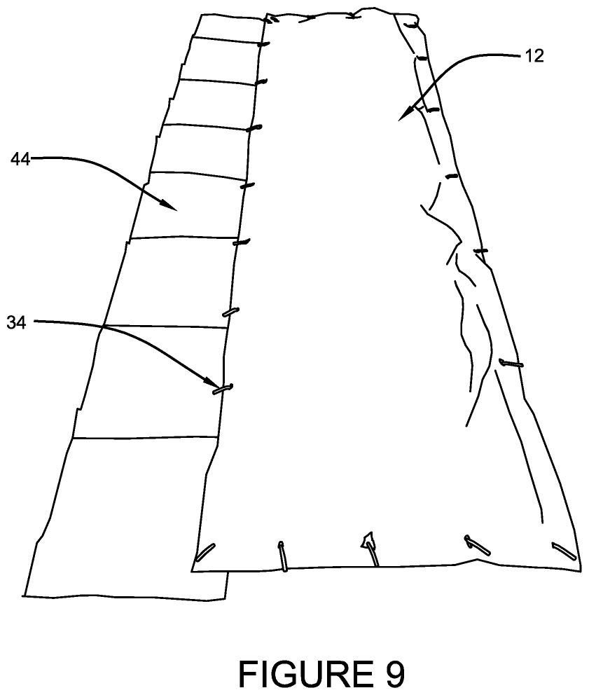

With reference now to FIG. 9, the no-till gardening system 10 may include a weed guard 44. The weed guard 44 may be placed about at least one of the outer edges of the no-till gardening system 10 so as to help ensure the absence of weed growth within the confines of the system. According to one embodiment, the weed guard 44 is of a slightly longer length than that of either of the upper or lower housing units 12 and 14. While the exact dimensions of the weed guard 44 may vary according to different adaptations of the unit, the embodiment shown in FIG. 9 may be of an approximate width of approximately 15 inches and of a generally rectangular shape. A series of punctures, or openings, may be created about one lateral edge of the weed guard 44 which are of approximately the same nature as that of the openings created in each of the upper and lower housing units 12 and 14, respectively. The weed guard 44 may be placed beneath that of either, or both, of the upper and lower housing units 12 and/or 14 whereby the various anchoring units 34 may be inserted through the openings and subsequently secured to the ground. As shown in the embodiment of FIG. 9, the weed guard 44 is placed beneath that of both the upper and lower housing units 12 and 14.

The weed guard 44 may be placed about any of the four sides of the no-till gardening system 10. Multiple weed guards 44 may further be used in conjunction with one another, with as many as four weed guards 44 being used for any single unit. As the various sides of the no-till gardening system 10 are of different lengths, the weed guards 44 may similarly be of different lengths and proportions. According to one embodiment, the weed guard 44 is a single sheet of that material from which both the upper and lower housing units 12 and 14 are manufactured from and of a predetermined length relative to that of either the upper and/or lower housing units 12 and 14. An alternative embodiment may consist of a series of smaller units, of the same material from which the upper and lower housing units 12 and 14 are manufactured, which may be joined together so as to form a weed guard of variable length at the discretion of the user. The series of smaller units may thus be affixed to one another, such as by staples, an adhesive, stitching, or otherwise, so as to create a single continuous weed guard 44 which may traverse substantially the length of the upper and lower housing units 12 and 14.

The use of a weed guard 44 may be in conjunction with either of the various types of securement devices discussed above. Thus, the weed guard 44 may be used either in the presence of an attachment tab 32, or alternatively, in the absence of an attachment tab 32. The use, or lack thereof, of an attachment tab 32 should have no substantial effect on the efficiency of the weed guard 44 to prohibit the growth of weeds within the system.

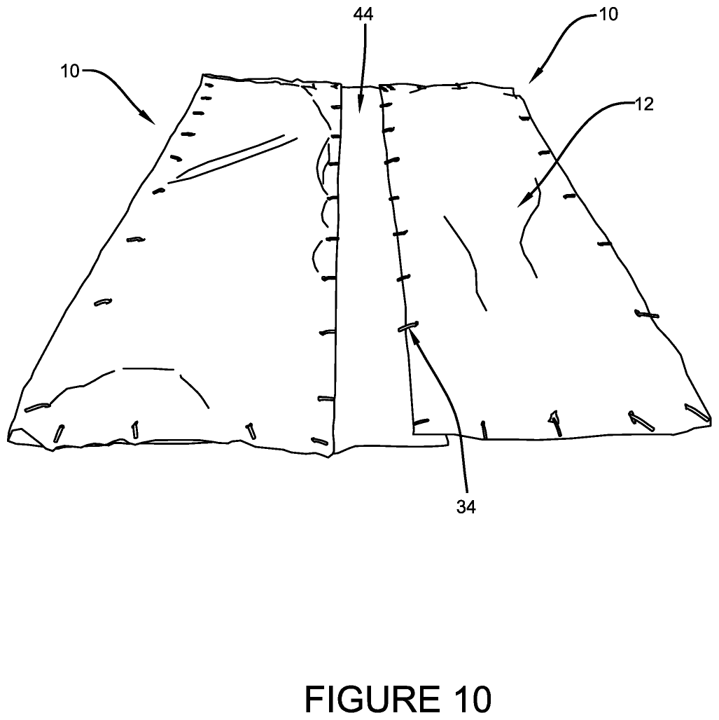

With reference now to FIG. 10, a single weed guard 44 may be used in conjunction with multiple no-till gardening systems 10. By aligning two separate units about their relative lengths, spaced apart by a distance approximately that of the width of a weed guard 44, a single weed guard 44 may be placed therebetween so as to conjoin the two units and prohibit the growth of weeds with respect to each individual unit. According to this configuration, the weed guard 44 will have openings created about either of the lateral ends so as to receive anchoring units 34 from each of the respective units. As the weed guard 44 is thus surrounded about both of its lateral edges by a no-till gardening system 10, a single weed guard 44 is capable of prohibiting the growth of weeds on each of the respective units. This principle may be similarly applied to the arrangement of multiple units in a row-type series. According to this type of configuration, a single weed guard 44 would run about the width of each unit, thereby conjoining one unit by the “top” portion and the other by the “bottom” portion. For either type of configuration, multiple weed guards may be utilized for any different number of units arranged according to the desired configurations of the user. By way of one example, a third no-till gardening system 10 could be placed on either side of the already existing two units shown in FIG. 10, with a second weed guard 44 used so as to conjoin this third unit to that of the already existing unit in the same manner as is shown.

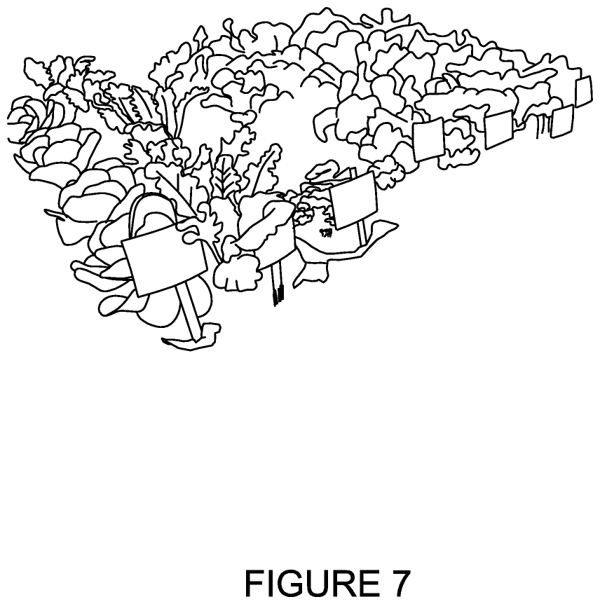

Following the securement of the no-till gardening system to the ground below, the unit is then in a “grow-ready” condition. General practices for starting and supporting plant life must then be adhered to. By way of one example, water is gently added such that the entire system becomes sufficiently wet, or “soaked”. This process is then repeated on a daily basis for approximately three to four days. Upon expiration of the fourth day of watering, water may subsequently be added every other day until plant life, or sprouting, begins to occur. As plant life begins to blossom, it will grow directly through the perforations 16 located on the upper housing unit 12, as shown in FIG. 7. Over time, the upper housing unit 12 will begin to dissolve while the seeds undergo the germination process. As the upper housing unit 12 is constructed from an environmentally-friendly material, such material will be reclaimed by nature and disappear over the months which follow. If any material remains at the end of the growing season, it can be discarded or recycled.

As described above, the present disclosure has been described in association with various aspects thereof and it is understood that many changes and modifications to the described aspects can be carried out without departing from the scope and the spirit of the present disclosure that is intended to be limited only by the appended claims.

Having thus described the invention, it is now claimed:

I claim:

1. A method of using a no-till gardening system comprising the steps of:
placing a lower housing unit on a ground surface;
adding a mixture of soil and plant seed on top of the lower housing unit;
placing an upper housing unit on top of the lower housing unit, wherein the mixture of soil and plant seed rests between said upper and lower housing units, and each of said upper and lower housing units further comprises at least one perforation;
affixing said upper and lower housing units to the ground by way of at least one securement device, wherein said at least one securement device further comprises an anchoring unit, and;
watering the system to allow for plant growth.

2. The method of claim 1, wherein said anchoring unit is U-shaped.

3. The method of claim 1, wherein said at least one securement device further comprises an attachment tab, said anchoring unit is U-shaped, and said U-shaped anchoring unit is affixed to said attachment tab by way of a fastener.

4. The method of claim 1, wherein said upper and lower housing units are attached to one another by way of a central spine held together by at least one staple.

5. The method of claim 4, wherein the no-till gardening system further comprises at least one weed guard positioned about at least one edge of the upper and lower housing units, wherein said at least one weed guard is secured beneath the lower housing unit by the at least one securement device.

6. The method of claim 5, wherein the soil is added in a layer measuring at least 2 inches in height relative to the ground surface, the at least 2 inch layer of soil runs substantially the length of the upper and lower housing units, and the width of the soil running the length of the upper and lower housing units is at least 30 inches.
